(19) United States
(12) Patent Application Publication
(10) Pub. No.: US 2007/0022276 A1
(43) Pub. Date: Jan. 25, 2007

(54) Method and System for Processing a Work Item in a Pipelined Sequence

(76) Inventors: Rolf Fritz, Waldenbuch (DE); Andreas Koenig, Leonberg (DE); Susan Marie Rubow, Hyde Park, NY (US); Christopher Smith, Tamm (DE); Gerhard Zilles, Jettingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/458,482

(22) Filed: Jul. 19, 2006

(30) Foreign Application Priority Data
Jul. 25, 2005 (EP) 05106814.6

(51) Int. Cl. G06F 9/44

(52) U.S. Cl. 712/227

(57) ABSTRACT

The present invention relates to the processing of information in a computer with multiple stages wherein in each stage a particular, stage-specific work is done with or without stage-specific data. The present invention in particular adheres to the tracing of events which happen in each of these stages. In order to provide a method which generates trace information for work items which can be easier evaluated, it is proposed to perform the steps of: generating an entry in a trace pipeline for a work item; selecting a subset of trace information generated during the processing of said work item in a processing stage, adding said subset to said entry, and putting said entry to the next stage of said trace pipeline in every stage of said processing stages.

### BACKGROUND OF THE INVENTION

1. Field of the Invention

The present invention is within the general field of computer-aided information processing, wherein the processing comprises multiple stages wherein in each stage a particular, stage-specific work is done with or without stage-specific data. The present invention particularly relates to the tracing of events which happen in each of these stages.

2. Description and Disadvantages of Prior Art

The present invention can be implemented in a computer processor which uses a pipelined architecture 10 as for example disclosed in U.S. Pat. No. 6,023,759 and schematically depicted in FIG. 1.

FIG. 1 is a schematic block diagram representation of command pipeline architecture 10 including a buffer 13 for storing error signalling and trace information resulting from cash cycle (denoted 1, . . . , x) and the totality of all pipeline stages in respective snapshots 11-1, . . . , 11-x “over all stage outputs”;

In each stage 11, 12, 13, 14, 15 of the pipeline 10 some trace information 1, 2, 3, 4, 5 is stored in a respective, separate trace entry in order to provide additional information which can be evaluated for repairing errors occurred during a respective processing in each pipeline stage. Prior art discloses to take a snapshot 11-1, . . . , 11-X of each status outputs for all pipeline stages in each cycle at times T1, . . . , Tx and to store the event-related information in a respective separate trace entry. Then a filter function 16 might be applied, and filter output may be stored in a trace memory 18.

This approach has the disadvantage that trace information collected in a single entry comprises information of different semantic objects which are mostly independent from each other. In order to be able to follow the timeline in the processing of one and the same object, e.g. the processing of a single command, a user must gain a synthesis view across different trace entries, which is quite complicated as the majority of information comprised of a single trace entry has nothing to do with the interesting command.

It is quite surprising that this classical situation of multi-stage processing is found also for general information processing, as the rule behind is to invoke a separate function for doing a specialised task wherein the invoked function will certainly invoke a further function in a next lower level for performing at least parts of the task, etc. Each function and subfunction corresponds to a separate stage of processing. Error tracing on this abstract level, however, is also performed according to the before-mentioned principle that each stage generates its own error log. When then one and the same subfunction processes is fed with items of different semantic meaning in a typical processing sequence, then the error catalogue is also ordered in a timeline, in which different errors associated with different semantics are mixed up in a common storage. Thus it is easy to trace the work of the subfunction over all preceding items of work just by reading the sub function's error log. But this is mostly not of interest when a single piece of work, for example a data item, shall be monitored over a plurality of subsequent processing stages.

At least this principle of stage-specific/function-specific error information storage involves that it is difficult to trace the processing of a single specific work item, as this work item's error information must be collected from a plurality of sub function's error logs. This is resulting in multiple read accesses into respective stage-specific error logs and in each error log it is a hard work required for identifying the interesting work item.

Thus, a person skilled in the art may appreciate that the situation of processing a work item in multiple operational stages in a pipeline may occur very often in different technical applications of information processing. In the particular field of computer processor development the before-mentioned tracing is a task usually done during the bring-up of the hardware. A person skilled in the art may appreciate that disadvantageously trace information is distributed over a plurality of different locations and must generally be collected by the tracing user in a complicated way.

Thus, a more effective method is needed to trace debug and utilization information for the processing of one and the same piece of use data in a series of a subsequent processing stages, or in the particular case of a complex command processing pipeline.

### OBJECTIVES OF THE INVENTION

It is thus an objective of the present invention to provide a method for managing a multiple stage processing according to the preamble of claim 1 which generates trace information which can be easier evaluated.

### SUMMARY AND ADVANTAGES OF THE INVENTION

This objective of the invention is achieved by the features stated in enclosed independent claims. Further advantageous arrangement and embodiments of the invention are set forth in the dependant claims. Reference should now be made to the appended claims.

According to the broadest aspect of the present invention a separate trace pipeline is used which collects all event-related information and accumulates this information in one and the same pipeline entry. Thus, in the first stage of a processor command pipeline probably the command ID is stored whereas in the separate pipeline stage the trace pipe entry is enriched by particular information generated by the second stage of the command pipe. Finally, in the last stage of the command pipe respective last event-related information is stored in the last trace pipe entry still featuring the same command ID. This basic procedure advantageously provides an easy overview reflecting the whole history of the “evolution ” of a piece of use data subjected under the multiple stages of processing when inspecting a trace pipe entry, as all the history information starting at the lowest level of the command pipeline and ending with the last level is completely collected in a single trace pipe entry.

In other words, the generation of an error trace pipeline is proposed for generating a trace entry separate for a respective single piece of work, as for example a command or a piece of data that reflects the whole history of this work item. Advantageously this entry is generated in the first stage of the trace pipeline in synchronisation with the first stage of the “real processing pipeline” with all information needed to identify the respective piece of work. In generally this is an adequate ID of this piece of work; in case of a command pipeline this would be the command ID.

Optionally, with a particularly elevated value for processing environments, in which per time-unit a huge number of work items are processed—typically in a computer's command pipelines—after the pipeline processing has been finished a filter-function can be preferably implemented which stores only trace pipe entries with a predefined attribute in a further separate trace memory as it is known in prior art. Such attribute may be for example the occurrence of an error during command processing. In other applications this attribute may be any predefined feature of freely selectable meaning calculated during runtime of a piece of work, definitely anything which may be programmed and can be subsumed under a single semantic unit.

As a person skilled in the art may appreciate all relevant trace information of a work item which stands within a single semantic context can be stored at a single storage space in an order which reflects the timeline of processing this work item.

Further, when the before-mentioned filter function is implemented all trace information relating to error-free processing or to not-interesting subject matter is not required to be saved in a separate store. This enables for significant savings of storage space.

According to a further preferred feature of the invention a trace entry has a fixed length adapted to the respective needs of a processor. This allows a trace pipeline implementation with a simple structure.

### BRIEF DESCRIPTION OF THE DRAWINGS

The present invention is illustrated by way of example and is not limited by the shape of the figures of the drawings in which:

FIG. 1 is a schematic block diagram representation of prior art command pipeline architecture including a buffer for storing error signalling and trace information resulting from each cycle and the totality of all pipeline stages in respective snapshots “over all stage outputs”;

FIG. 2 is a schematic block diagram representation illustrating the basic structural elements implemented according to a preferred embodiment of the invention;

FIG. 3 is a schematic block diagram representation illustrating the basic structural elements implemented according to a preferred embodiment of the invention, when applied to a command pipeline processing commands with a command and a data section;

FIG. 4 is a control flow diagram illustrating the control flow in a preferred embodiment of a method in accordance with the invention, when applied to a pure software application without a particular relation to program commands, and

FIG. 5A is a schematic command and data entry representation (top) and a trace entry representation (bottom), seen in the perspective of the filter 16,

FIG. 5B is a representation according to FIG. 5A, seen in the perspective of the trace memory, and

FIG. 5C is a representation according to FIG. 5B, showing the trace entries with respective members of the trace stream connected by arrows.

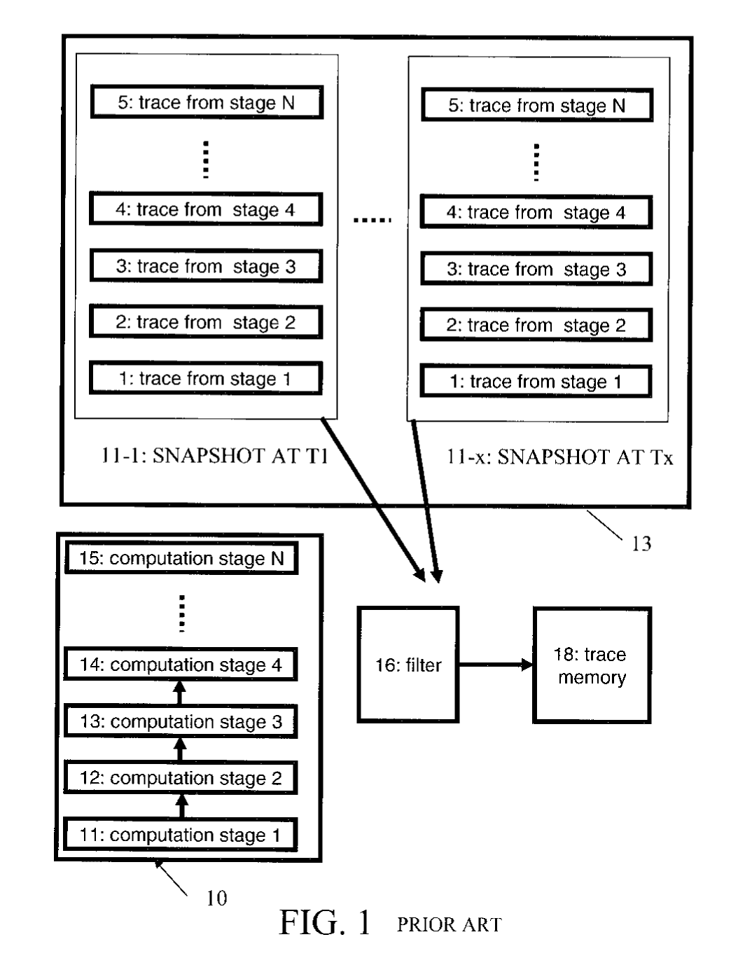

### DETAILED DESCRIPTION OF THE PREFERRED EMBODIMENT

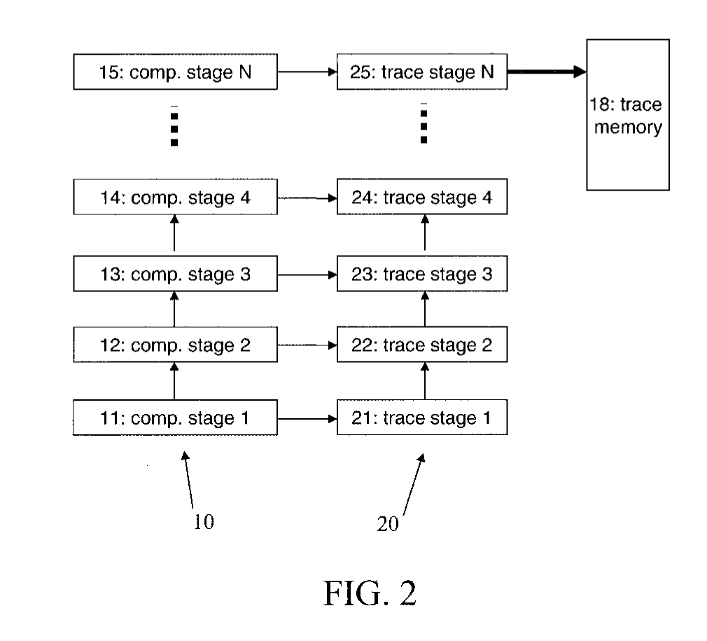

With general reference to the figures and with special reference now to FIG. 2 a primary command pipeline 10 is used as depicted and described in the prior art discussion context. It comprises processing stages 1 to N depicted with reference signs 11 to 15. With particular respect to the present invention in parallel to the processing pipeline a separate trace pipeline 20 is implemented in a respective way corresponding to the primary pipeline. That is, in particular when in the exemplary case of a command pipeline in a computer processing unit, both pipelines are fully implemented in hardware.

The trace pipeline 20 comprises also trace stages 1 to N depicted with numerals 21 to 25 in order to offer a temporary storage space for storing all relevant trace data information which is traceable in each of the stages of the primary pipeline in a respective storage location at the trace pipeline. Thus, with respect to one specific command travelling through the command pipeline (primary pipeline from stages 1 to N) an adequate storage structure is created with this trace pipeline in order to be able to generate one trace entry per command that reflects the whole history of the command on its way through the primary pipeline. In particular, in stage 1 it is required to identify the command with a respective ID. Then, advantageously all trace information of stage 1 is stored in the trace entry of trace stage 1 under this ID. Then, in stage 2 the trace information of stage 1 is still present. As soon as the processed command moves to the second stage, the according trace entry with all trace information from trace stage 1 is also moved to the second trace stage.

The new trace information relevant from the processing in stage 2 is added to the trace information already present in this trace entry. The same addition of trace information is done during the processing of the rest of the primary stages. In the end, i.e. the output of the primary pipeline processing all relevant trace information is collected in a series of added sections wherein each section holds the trace information of a respective preceding primary pipeline stage processing. Thus, in the end of the processing of the primary pipeline the trace entry of the trace pipeline in stage 25 (trace stage N) offers a complete list of trace information for one and the same command. This trace entry can then be stored in a separate storage as depicted with trace memory 18 in FIG. 2.

In a further variation a filter function 16 is applied to the content of the trace entry before storing the entry from stage N of the trace pipeline in order to store only interesting cases. Interesting cases can be defined quite freely and comprise in particular error cases in cases of command processing.

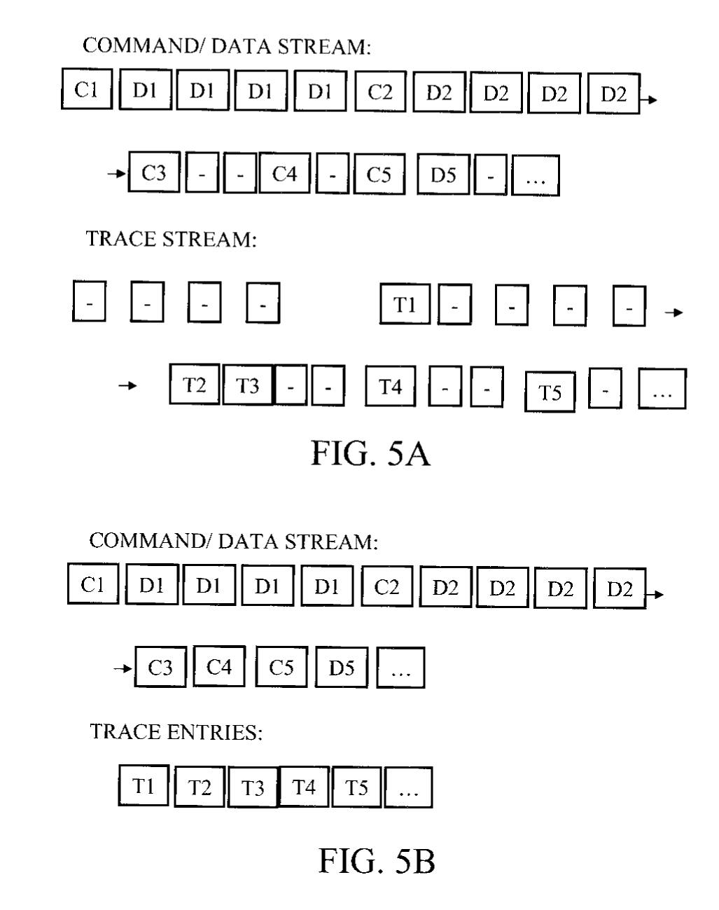

With further reference to FIG. 4 the control flow of a further preferred embodiment is depicted comprising the leading steps performed in an exemplary software application which can be freely assumed to implement any business method of interest. The most important technical feature in this embodiment can be clearly identified in context to the technical problem how to organise meta information which is available in each specific stage of the primary processing workflow, such that it can be retrieved in a simple and efficient manner when a processed work item as a part of the business method leaves the primary pipeline.

In this general respect in step 310 a trace attribute can be freely defined. It could be for example to trace all error-relevant meta information, or any cost-relevant meta information, or any stuff-related meta information, etc. In this exemplary depiction simply the attribute “all” is defined in order to collect all meta information visible and available at each specific stage in the sequential processing of the workflow.

In a step 320 the processing pipeline and the trace pipeline are defined by identifying respective processing steps of the business method which must be processed in a certain predefined order. Further, the storage space is allocated in order to be able to store and retrieve the intermediate results in each pipeline stage of the primary pipeline and in order to implement the accumulation of trace information with an increasing storage need during the processing through the multiple pipeline stages. For example in a networked environment of a workflow system where the workflow system is a distributed application spanning over multiple parties in the network the trace entry can be implemented in a data base in a respective storage area with a dynamic management. Alternatively, each local computer which calculates a certain pipeline stage can implement a local storage of the trace entry accumulating the preceding trace information to its own trace information, and forwarding this accumulated trace information to the next local computer system processing the respective next stage, wherein this procedure is repeated thus yielding a complete set of trace information at the last stage of the primary pipeline.

When all preparations are done a given work item can be entered into the first stage of the primary pipeline, step 330. Then in a subsequent loop of steps 340, 350 and 360 the work item is processed in the multiple stages and trace information is stored in each stage, wherein new trace information is preferably added to the before-existing trace information. This is basically done until the last stage in the primary pipeline has been reached, see step 370. Then in an optional variation a filter criteria can be applied in order to filter the trace information according to any predefined criteria. Then in step 380 all trace information is stored at an exterior storage other than the pipeline itself for all trace content fulfilling the filter criteria.

The method can also be implemented in a programmed hardware like offered in ASIC solutions.

Thus, according to the invention a separate trace pipeline is used in parallel to the command processing pipeline. Since the trace entry and the command are always travelling in parallel the trace entry will contain all information of one command in one final trace entry that is written to the trace memory in the same cycle the command leaves the command processing pipeline. The last stage of the trace pipeline is able to use a variable granularity to write small trace entries for commands that didn't hit any problems on their way thru the command processing pipeline while a more detailed trace entry is written for commands that hit problems.

Since there is only one trace entry written per command, those entries can easily be read and represent the whole information and history of a command. During idle cycles no entries are written.

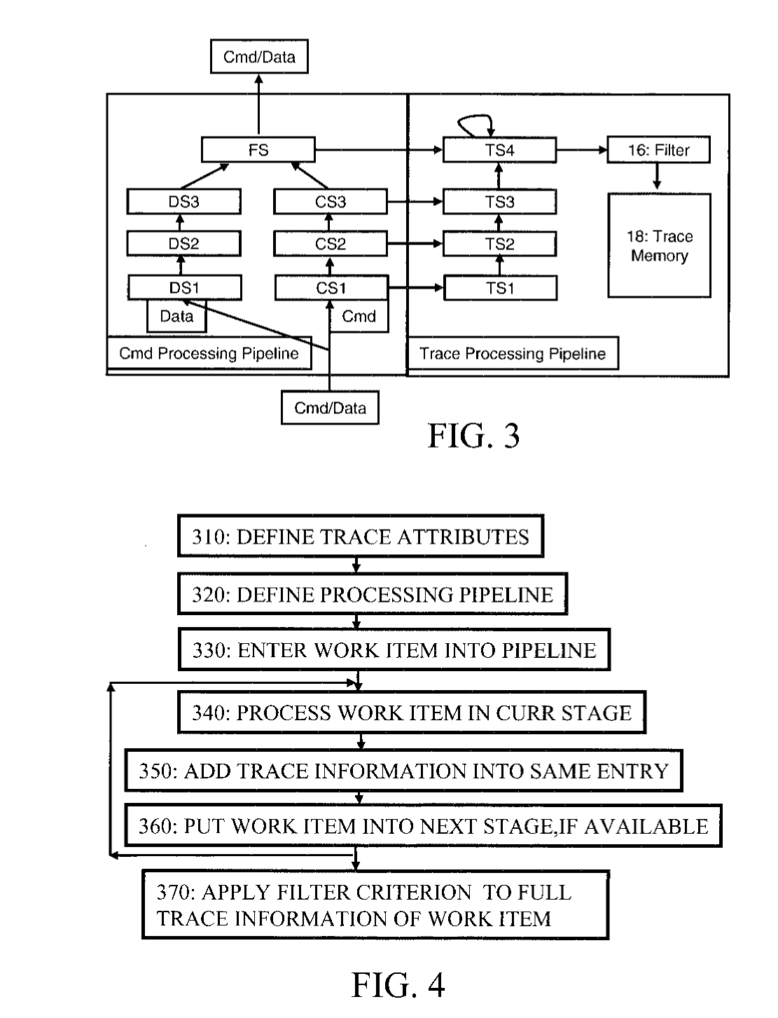

In this example of FIG. 3 the description of FIG. 3 can be generally applied. The particularities are that the commands are shown to be separated into data sections (DS) 31 to 33 and command sections (CS) 41 to 43.

The commands with respective data entry the Cmd Processing Pipeline via input registers 40. All commands are one shot and followed by 0 to x data shots that belong to this command. CS1, CS2 and CS3 are the command processing stages, while DS1, DS2 and DS3 are only delay stages for the data shots to make sure that the data shots don't pass the commands that have to go thru the three command processing stages.

FS is depicted to be the final stage 44 of the primary pipeline. Commands as well as data shots have to go thru this stage for a final check. TS1 to TS4 are depicted to be the stages of the trace pipeline. When a command enters CS1, an initial trace entry 51 is generated in TS1. This trace entry travels in parallel to the command up to trace entry 54 (TS4), where it remains until all data shots left the final stage FS 44.

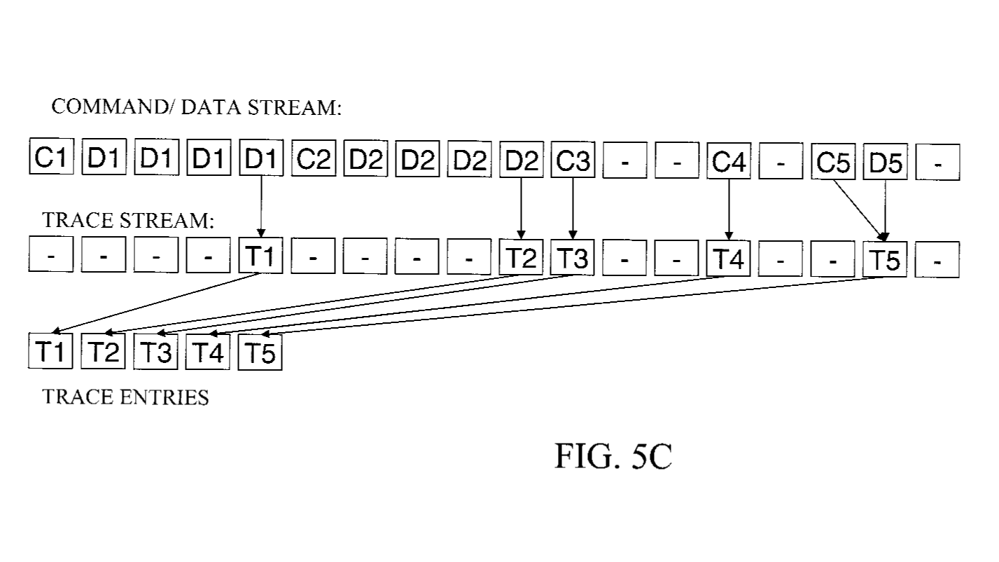

With reference to FIG. 5 an example is given that shows the created Trace Entries (Tx) that reflect the whole History of a Command (Cx) including it's Data (Dx).

A “-” indicates an IDLE cycle. The Command/Data Stream is shown from a “FS” Stage perspective and the Trace stream is shown from a Trace Filter perspective in FIG. 5A, and the trace entries are shown in FIG. 5B.

A command and data entry representation (top) and a trace entry representation (bottom) is depicted in FIG. 5A, in two lines respectively, seen in the perspective of the filter 16 only in order to improve clarity.

FIG. 5B shows the same seen from the Trace memory, wherein the filter criterion is set to trace “ALL”. As appears clear from the drawings, no IDLE entries are written into the trace memory 18.

FIG. 5C shows the trace entries connected by arrows with respective members of the trace stream in order to illustrate the time-dependency between stream and the generation of trace entries, and the compression effect obtaining when deciding not to store IDLE as trace information; the trace entries are created sequentially, one after the other in the order given by the trace stream.

This trace entry contains content only from the processing of one and the same command on its walk through the command pipeline.

A filter unit 16 is shown to be fed with the content of the final trace pipeline entry 54. This is the place where the decision is made whether the trace entry leaving TS4 is stored to the trace memory or not and which granularity is the most efficient for this trace entry. All information to make this decision can be found in the trance entry itself. Trace entries that show that the command including it's data are processed as expected (i.e. without error) can be stored with a much smaller trace entry than commands that hit unexpected problems. In the second case a much more detailed trace entry should be stored to allow a better analysis of the hidden problems.

The present invention can be realized in hardware, software, or a combination of hardware and software. A trace information accumulator tool according to the present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A method for processing a work item in a pipelined sequence of multiple processing stages in a computer, wherein trace information is generated during the processing of said work item in a plurality of said processing stages,
the method being characterized by the steps of:
generating an entry in a trace pipeline for said work item;
selecting a subset of trace information, adding said subset to said entry, and putting said entry to the next stage of said trace pipeline in every stage of said processing stages.

2. The method according to claim 1, with the additional step of
selecting and deleting trace information from said trace entry after the last stage of said processing stages.

3. The method according to claim 1, with the additional step of:
storing said trace entry in a separate storage after the last stage of said processing stages.

4. The method according to one of claim 1, wherein said trace entry has a predefined fixed length.

5. A computer program loadable into the internal memory of a digital computer system and comprising software code portions for performing the method according to claim 1 when said program is run on said computer.

6. A computer program product stored on a computer usable medium comprising computer readable program means for causing a computer to perform the method of claim 1, when said computer program product is executed on a computer.

7. A data processing system comprising a trace pipeline implementation and a data interface to a primary operational pipeline for storing the trace information output from the primary pipeline in each stage.

8. The data processing of claim 7, where the entries in said operational pipeline are commands from the processing of instructions of a processor.
